(19) United States
(12) Patent Application Publication
(10) Pub. No.: US 2012/0054680 A1
(43) Pub. Date: Mar. 1, 2012

(54) USER CONTROL OF USER-RELATED DATA

(75) Inventors: Rajas Moonka, San Ramon, CA (US); Anurag Agarwal, Sunnyvale, CA (US); Oren E. Zamir, Los Altos, CA (US)

(73) Assignee: GOOGLE INC., Mountain View, CA (US)

(21) Appl. No.: 13/221,084

(22) Filed: Aug. 30, 2011

Related U.S. Application Data
(60) Provisional application No. 61/379,293, filed on Sep. 1, 2010.

(51) Int. Cl. G06F 3/048

(52) U.S. Cl. 715/810

(57) ABSTRACT

A method comprises receiving at a data exchange a request to review user data that has been gathered by one or more data holders and that relate to a given user, where the user data is being marketed for use in the data exchange, where the request includes an identifier associated with the user. The method further comprises providing a user interface for the user to review the user data wherein the user data includes information, if any, regarding user lists that the user belongs to and an identity of a data holder that is associated with the user lists

### CROSS-REFERENCE TO RELATED APPLICATION

This application claims priority to U.S. Provisional Application No. 61/379,293, filed on Sep. 1, 2010. The disclosure of the prior application is considered part of and is incorporated by reference in the disclosure of this application.

### TECHNICAL FIELD

This document relates to user information used for presenting and targeting content.

### BACKGROUND

Providing relevant advertising content to users is generally important to advertisers and service providers. However, implementing a cost-effective way of providing such relevant advertising content can prove difficult in an ever-changing online market. Further, while relevant information for targeting a particular user may be known by one entity, users may or may not know what information about them is held or shared by online entities.

### SUMMARY

This document discusses systems and techniques by which users can control user-related data.

In another aspect, a method comprises receiving at a data exchange a request to review user data that has been gathered by one or more data holders and that relate to a given user, where the user data is being marketed for use in the data exchange, where the request includes an identifier associated with the user. The method further comprises providing a user interface for the user to review the user data wherein the user data includes information, if any, regarding user lists that the user belongs to and an identity of a data holder that is associated with the user lists.

Implementations can include any, all, or none of the following features. The user interface includes meta data derived by the data holders or the data exchange about the user. The metadata includes inferred data and/or actionable data including events that were used to produce the metadata. The user interface includes providing information as to subscribers to a user list in which a user is a member. The subscribers are syndicates or sub-syndicates. Providing the user interface includes providing metadata relating to whether data associated with a user's membership in a user list was uploaded and if so when. Providing the user interface includes providing metadata relating to whether data associated with a user's membership in a user list was based on online tags and which websites those tags were provided from. Providing the user interface includes providing metadata relating to the user and whether at least a portion of the metadata was inferred or was user provided. The method further comprises, for user provided data, providing a user interface that includes information as to which website the user data came from. The method further comprises, for user inferred data, providing an indication of who made the inference. If a user's data has been syndicated, providing the user interface includes providing a syndication chain that shows all entities that have access to the user's data including the data holder. Providing a user interface includes providing information including a link to privacy policies under which any data was collected by a data holder. The information includes the web sites where the user's data was collected, the source if the information is off-line and the principal key on which the data is indexed. The method further comprises providing an interface for users to opt out of user data collection by a specific originating data source. The method further comprises receiving user input to delete a portion of the user data. The deletion is a one-time event and does not prohibit the future gathering of similar data by the data holder. The deletion is permanent and will inhibit future collection by the data holder of similar data. The method further comprises receiving user input designating one or more data holders that are not allowed to maintain data for a given user. The user input includes user input specifying a blacklist of websites or categories of data holders that are prohibited from adding data about a user to a user list. Upon receipt of user input to delete a portion of data, determining other data associated with the user that should be deleted for consistency reasons and the method further comprising deleting the other data. The method further comprises receiving user input to suppress a cookie from being written to a user's client device for a predetermined period of time and the method further comprising providing the user input to one or more data holders to ensure that cookies are suppressed for the predetermined period of time. The method further comprises receiving user input to edit a portion of the user data. The data holder is presented to the user as an anonymous entity, and wherein the method further includes receiving user input to blacklist one or more data holders that have chosen to be anonymous and removing user data associated with the user for the one or more data holders. The method further comprises receiving user input indicating one or more restrictions for use of a user's data. The method further comprises enforcing the one or more restrictions. The restrictions relate to dynamic ad generation, targeting and reporting, including restrictions that exclude certain entities and systems from using the data. The restrictions relate to sites the user specifies so that user data can only be used on sites specified by the user. The method further includes conditions on use of user data, where the conditions relate to money to be paid by consumers of user data. The conditions specify an entity other than the user for receiving a portion of the money paid by consumers of user data. The method further comprises providing statistical information to the user related to monies paid to subscribers of a user's data. The method further comprises providing relative statistical information to the user related to monies paid to subscribers of a user's data. The method further comprises receiving user input including identification of a persistent authentication data entity related to the user and associating the persistent authentication data entity with the user data. The method further comprises providing a tool to allow a user to see what user data has changed since a last time that the user reviewed the user data. The method further comprises providing in the user interface an indication of whether the user data has changed since a last time a user reviewed the user data. The method further comprises providing a tool to allow a user to become a member of a user list of which the user is not currently a member. The method further comprises providing a tool to allow a user to display statistics related to audience insights/analytics related to the use of the user data. The method further comprises providing a tool to allow a user to opt out of a complete set of anonymous sources associated with the user data.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram of an example system for providing and using shared data.

FIG. 2 is a schematic diagram of example user lists.

FIG. 3 is a screenshot of an example user interface for displaying and controlling the use of user-related information.

FIG. 4 is a flow diagram of an example process for providing a user interface for a user to review and control the use of user-related data.

FIG. 5 shows an example of a computer device and a mobile computer device that can be used to implement the techniques described here.

Like reference symbols in the various drawings indicate like elements.

### DETAILED DESCRIPTION

Advertisers, publishers, and service providers generally may wish to exchange data for purposes of implementing a meaningful way of providing information and/or services (e.g., advertising content) to online users. If specific content is determined to be meaningful to a particular user, then the user may wish to access the content, purchase the content, or otherwise interact with the content. This interaction can provide revenue to the content provider (e.g., advertiser, publisher or service provider). If a particular content provider (e.g., advertiser, publisher, or service provider) can collect data about how specific content may or may not be meaningful to users (i.e., in the form of a user list), the collected data may be used by others in a variety of ways. One use relates to selecting targeted content. Other uses are possible, such as in adjusting bids in an auction based, for example, on user lists that indicate specific content is of interest to one or more users. User lists can be published, sold, licensed or otherwise accessed to assist in providing personalized content to the specific users and increasing revenue for a content provider. In some implementations, a user list can include: a numeric identifier, a short name, a free-text description (e.g., including a description of the process by which the user list was generated, what type of users are in the user list, etc.), the identifier and/or name of the user list's owner/holder, subscribers' names/identifiers, identifiers of the users who are members of the user list, and so on.

User lists can represent specific user information pertaining to predefined categories. The categories can be defined by the data owners (or “data holders” who can be owners of the user lists). For example, a user list may include data about one or more users which characterizes the users to a category (e.g., homeowner, craftsman, DVD renter, etc.) to allow targeting of the users by, for example, publishers or advertisers. In some implementations, the user lists can be used to target relevant advertising content.

User lists can be generated and exchanged according to a number of rules, and those rules can be used to market particular user lists to specific consumers. The rules can employ methods of assigning users to particular user lists. Such rules can provide a logical categorization of data, information, or services for the purposes of determining which data content in the user lists is particularly relevant to a number of users.

Methods are described for associating user specific information with one or more user lists that are owned or maintained by a data owner. An association between the user-specific data and the user lists is made. The association can be exploited, for example, for real-time bidding in response to requests for content or to customize content to be provided to a specific user. Other uses of the user list information and associations are possible.

In some implementations, users can have a website where they can go to view, edit, and/or delete data about them and to modify their settings. The website can provide user interfaces for registering with the website and for controlling their user-related data.

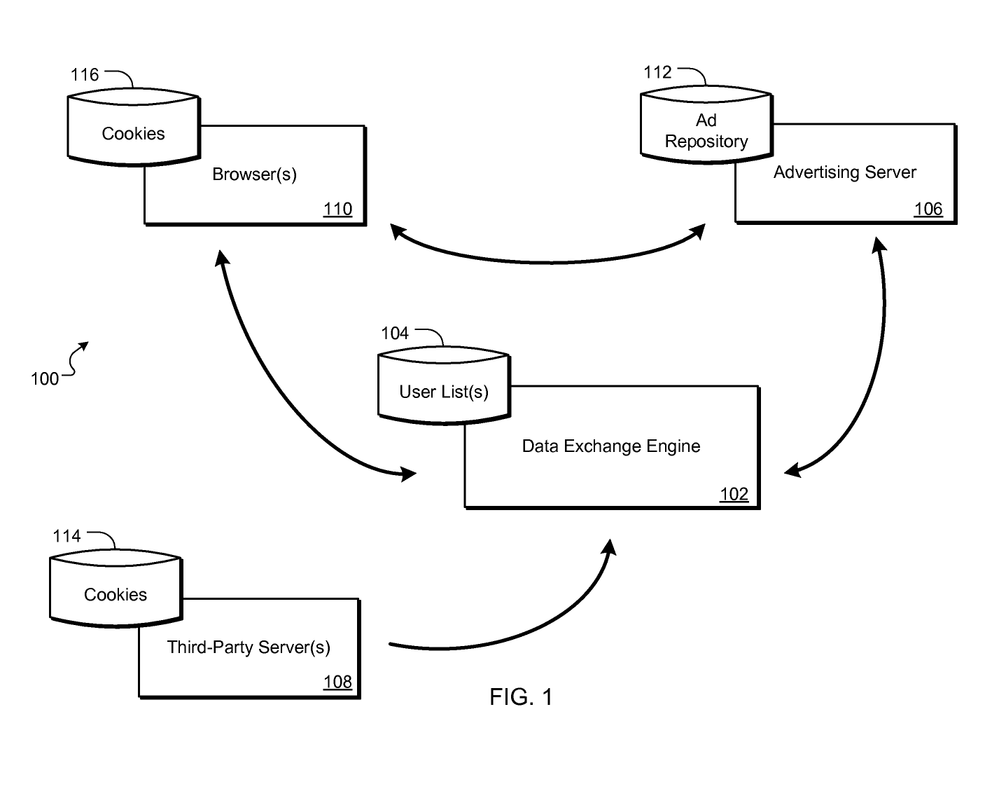

FIG. 1 is a schematic diagram of a system 100 for providing and using shared data. The shared data can, for example, include user-related data of the form of user lists detailing a number of predefined categories pertaining to specific users. The categories can be defined by or relate to user information including, but not limited to, browser history, user selections, cookie information, user-provided preferences, purchase histories, web search data, or other data (i.e., where the user has provided permission for the storing and/or collecting of such data). In some implementations, a user list is owned by a data provider that gathered the information in a respective user list. In some implementations, the user lists can be shared with other entities, such as for example using a data exchange. For example, the user lists can be shared amongst advertisers, third-party service providers, or third-party advertisers, data aggregators, and other online users.

The user lists can be provided to the data exchange and maintained by the data exchange and/or by the data owners. User lists can be updated as appropriate to either refine the category/categories associated therewith or the users that are members of a given list. Management of user lists is described in greater detail below.

The system 100 includes a data exchange engine 102 for providing an interface for advertisers and other consumers to discover and/or license user lists 104. The data exchange engine 102 can be configurable to maintain, update, present, license, sell or otherwise manage one or more user lists based on owned or permissioned data. The generated user lists can include user-specific associations characterizing specific online user behavior. The associations can be used, for example, to provide personalized content from an advertising server 106, a third-party server 108, or other content provider. The data exchange engine 102 as described here may parallel the functionality of an online advertisement exchange system for active targeted online advertisers, for example.

In some implementations, the data exchange engine 102 can create an exchange between owners of permissioned data and consumers of such data. Consumers of the permissioned data can include advertisers that seek to target particular categories of users. In some implementations, the data exchange engine 102 provides a mechanism for a provider of advertising placement services in targeted online advertising to make available additional third-party data sources to buyers of advertising space. In some implementations, the data exchange engine 102 can provide user lists to publishers, syndicates, and other data providers for various purposes, including the targeting of advertising content to users.

The data exchange engine 102 can provide an interface for data owners to securely view and manage their own data (i.e., manage a user list). For example, a data owner can generate and store information in a user list by entering data both manually and automatically. Other entities may be permitted to enter/maintain information in a user list. Publishers can also extract data for direct sales models or other marketing plans. Although computer hardware is not depicted in the data exchange engine 102, processors, memory, and other processing components may be included.

The advertising server 106 can provide advertising content to any number of browsers 110 via the data exchange engine 102 or directly. In addition, the advertising server 106 can be configurable for receiving advertising content requests and providing advertising content to requesting users. In operation, the advertising server 106 can select advertisements targeted based on one or more criteria and in view of data that is included in one or more user lists. The advertising server 106 can also provide access to other storage elements, such as ad repositories, in the example shown as ad repository 112. The ad repository 112 can be used to store advertising content associated with particular keywords, bidding criteria, advertisers, and targeting criteria. Data storage elements may include any one or combination of methods for storing data, including without limitation, arrays, hash tables, lists, and pairs. The advertising server 106 can access other similar types of data storage devices, such as user lists 104, for example. While reference is made to providing advertisements, the advertising server 106 can provide other forms of content.

In some implementations, advertisers can work with data providers to purchase or license user lists for purposes of targeting certain categories (e.g., demographic categories, interest categories, preference categories). The user lists can be analyzed for quality and other considerations. The advertisers can use the user lists for determining targeting criteria or to modify current bids, for example. In one example use case, an advertiser can subscribe for a period of time to a user list. The user list itself may be defined as being associated with a certain category (e.g., Internet shoppers interested in buying a sports car) of users. Requests for advertisements can be received by the advertising system, and the data exchange can be used to determine for a given user to which user lists the user is subscribed. In a real-time bid example, the advertisers that have subscribed to the user lists may be presented with the request (and necessarily information that the users satisfy the category(ies) associated with the user list(s)), and then may adjust/submit bids in consideration of such information. This is just one example of a use for the user list data.

The third-party servers 108 can provide third-party services to any number of browsers 110 via the data exchange engine 102. For example, the third-party servers 108 can provide web services, advertising services, or external APIs (application programming interfaces) to connect to a third-party server. The third-party servers 108 can include, for example, one or more servers executing a search engine application program. In some implementations, the third-party servers 108 can include a related information server or an advertising server. Third-party servers 108 can track user activity using, for example, cookies 114.

The browser 110 represents a user browsing the Internet. The browser 110 can access any website available on a network belonging to a person, or any other type of entity such as a company, enterprise, etc. For example, in FIG. 1 browser 110 can access a service or website. The service or website can be hosted by the third-party server 108, or alternatively by another server associated with system 100. A user can employ the browser 110 to search the Internet for services, information, or merchandise. The browser 110 can track user activity using, for example, cookies 116.

In some implementations, the advertising server 106 includes one or more advertisement customizers (not shown) operable to customize advertising content according to one or more user lists. In particular, an advertisement customizer can customize the display criteria, language, or other content of an advertisement according to user list information. For example, if a particular user list includes user-entered searching pertaining to purchasing a vehicle, the advertising server 106 can use the user-entered searching information (e.g., a cookie stored from performing a web search in a browser) to customize the display or content of an advertisement. The customization can, for example, provide the user with a more relevant advertisement.

In operation and for each generated user list, the system 100 can store, for example in a table-based repository, a list of user lists for which a particular user belongs. The table-based repository can, for example, be represented by a proprietary distributed storage system having a multi-dimensional sorted map as described in the paper entitled “Bigtable: A Distributed Storage System for Structured Data” by Fay Chang, Jeffrey Dean, Sanjay Ghemawat, Wilson C. Hsieh, Deborah A. Wallach, Mike Burrows, Tushar Chandra, Andrew Fikes, and Robert E. Gruber, the content of which is incorporated herein by reference in its entirety. The table-based repository represents a distributed storage system for managing structured data that is designed to scale to a very large size (e.g., petabytes of data across thousands of commodity servers). Each user list in the proprietary database can be included in one or more tables having multiple dimensions (one of which may be a field for time, allowing for versioning and garbage collection).

The system 100 can provide an index to the table-based repository. The index can be represented by, for example, a user cookie. For example, the table-based repository may be a set of rows and columns where the rows represent cookies corresponding to particular users and the columns represent a characterization associated with the user list, such as particular categories, keywords, websites, or other descriptive data.

At some point, the user browser 110 can make a request for advertising content from the advertising server 106 or the third-party server 108. The data exchange engine 102 can retrieve a list of user lists from the table-based repository associated with a received request from a given user and provide the request to identified consumers of the user lists. Any subsequent processing of the request can use the list, for example, for targeting, advertising customization and bid generation. The list of user lists or portions of the list can also be transmitted to a real-time bidder to provide the bidder with pertinent information about one or more users. Other uses are possible.

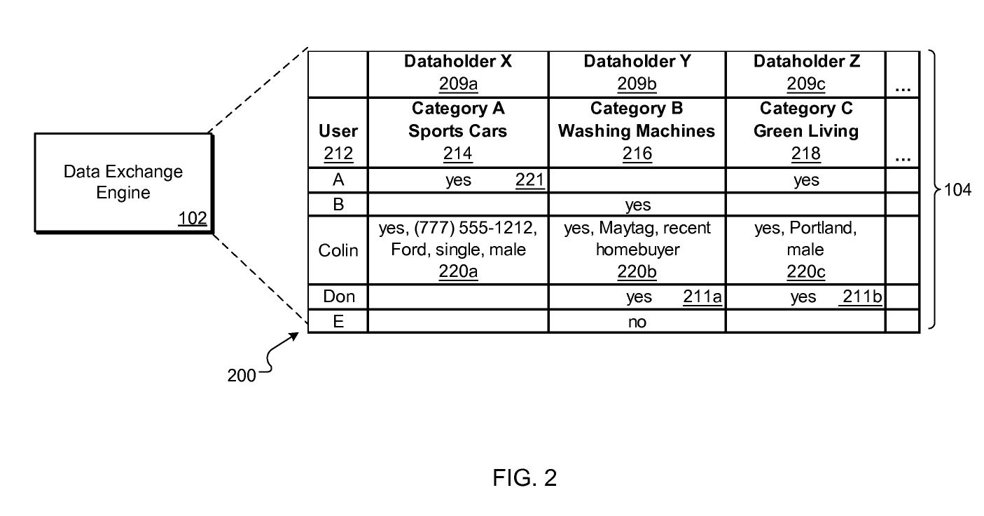

FIG. 2 is an example showing a schematic diagram of user lists 104 stored in a table 200. In this example, one or more entities (e.g., a web publishing entity that collected the user data) provided the user lists 104 to the data exchange engine 102. In some implementations, the user lists 104 in the table 200 are all provided by a same entity. In some implementations, the user lists 104 in the table 200 can include user lists owned/associated with different entities. For example, a given user list can be owned by a data holder which can gather user data for members of user lists and make the user lists available to (or market the data to) the data exchange engine 102. In the example table 200 shown in FIG. 2, the data holders associated with the user lists 104 are “Dataholder X” 209a, “Dataholder Y” 209b, and “Dataholder Z” 209c, where each column of the table 200 represents a separate user list. In some implementations, users can create their own user lists and provide the lists to the data exchange engine 102. For example, users can format content in user lists according to personal preferences and offer the user list data to the data exchange engine 102 for publication, management and use in targeting content to users. The data in the user lists 104 is developed, for example, based at least in part on user-provided, searching and browser data. In this example, the data exchange engine 102 can manage the user lists 104 which details users 212 A-E. In some implementations, the table 200 can be indexed by a user identifier, such as the users 212 column.

In the example shown, each row in the table 200 represents a single user, and further includes metadata for each user list to which the user is associated. A user identifier (not shown) can be used to identify a user. The user identifier can be a user identifier associated with a user in a domain associated with the entity that owns/provides the data (i.e., a local identifier). In some implementations, such as those where plural different entities provide user lists that are stored in a single table, the user identifier can be of the form of a global identifier associated with the user, such as an identifier that the advertising system assigns to the user. Global identifiers can be associated with “local” entity identifiers and mapped such that requests that include a local entity identifier can be associated with the global identifier and hence, can be associated with user lists associated with plural entities. As a user can be associated with multiple user lists owned by different data owners (or data holders), global identifiers can help to tie together those user lists for that user.

In the example shown, each column represents a user list that includes a characterization (sometimes referred to as a definition), such as by way of a particular category(ies), keyword(s), website(s), demographic(s), interest(s), or other user classification. Example characterizations in the table 200 include sports cars, washing machines, and green living (e.g., including environmentalists, recyclers, low carbon footprint individuals, etc.). The characterization can include descriptors, such as keywords, that describe a given category. Each characterization may embody the combination of plural separate categories or subject matter. For example, the characterization sports cars, may embody those individuals that visited a web site that were interested in cars and those that were particularly interested in sports cars (which themselves represent two different categories). In some implementations, logical combinations of categories or subject matter can be used to define the characterization for a given user list.

Columns 214-218 of the table 200 each can identify, at least at a high level, a different characterization associated with a different user list. For example, the column 214 identifies users characterized by “Category A Sports Cars.” Other example characterizations and associated user lists are represented by column 216 (i.e., “Category B Washing Machines”) and column 218 (i.e., “Category C Green Living”) to name a few examples. The table 200 can represent hundreds or thousands of characterizations and associated user lists.

In some implementations, each entry in the table 200 (i.e., the intersection of a row and a column) represents whether the user is a member of a given user list. For example, entry 210 indicates that user A is interested in or associated with a user list that has the characterization of sports cars, entry 211a indicates that user Don is interested in or associated with a user list that has the characterization of washing machines, and entry 211b indicates that Don is interested in or associated with a user list that has the characterization of people with “green” lifestyles. In some implementations, other data may be included in the entry. Other data can include geo-location data, cookie data, further personal data related to the user and known by the data owner, example web pages or example content (e.g., content surfed by the user), keyword searches, location data, website data, side vertical data, page vertical data, formatted text strings (where the data owner may include data related to the particular user in accordance with a definition set by the data owner (e.g., a series of bits that are set or not depending on the individual user's data for things like demographics, other interests, or other data that is different from the characterization but may be of use in targeting information to the particular user)) or other data. For example, entry 220a includes an indication that Colin is not only a member of the user list associated with category A (Sports Cars) but also that Colin's phone number is 777-555-1212, he has a preference for Fords, is single, and is male. In another example, entry 220b indicates Colin's membership in the Washing Machines user list, he prefers the Maytag brand, and he is a recent homebuyer. In yet another example, entry 220c includes an indication that Colin is not only a member of the user list associated with category C (green living) but also that Colin is located at a particular location (e.g., lives in Portland) and is a member of certain demographic groups (e.g., is male).

In some implementations, identification of the one or more user lists to which a person belongs can be made by the data exchange engine 102 when a cookie or other user identifiable information is received. In some implementations, the data exchange engine 102 uses the cookie or user identifying information as an index to the user lists 104. For example, the data exchange engine 102 can cross reference received user identifier data with particular user list information to determine an association between user list data and the cookie data/user information. As shown in user lists 104, a user (A) showed an interest in user list A which is characterized by the keywords “sports cars”, as indicated by a “Yes” entry 221. For example, the user may, as part of a session with a given data provider, have provided a request to view sports cars made by Lexus such as providing a keyword search for “Lexus sports cars.”

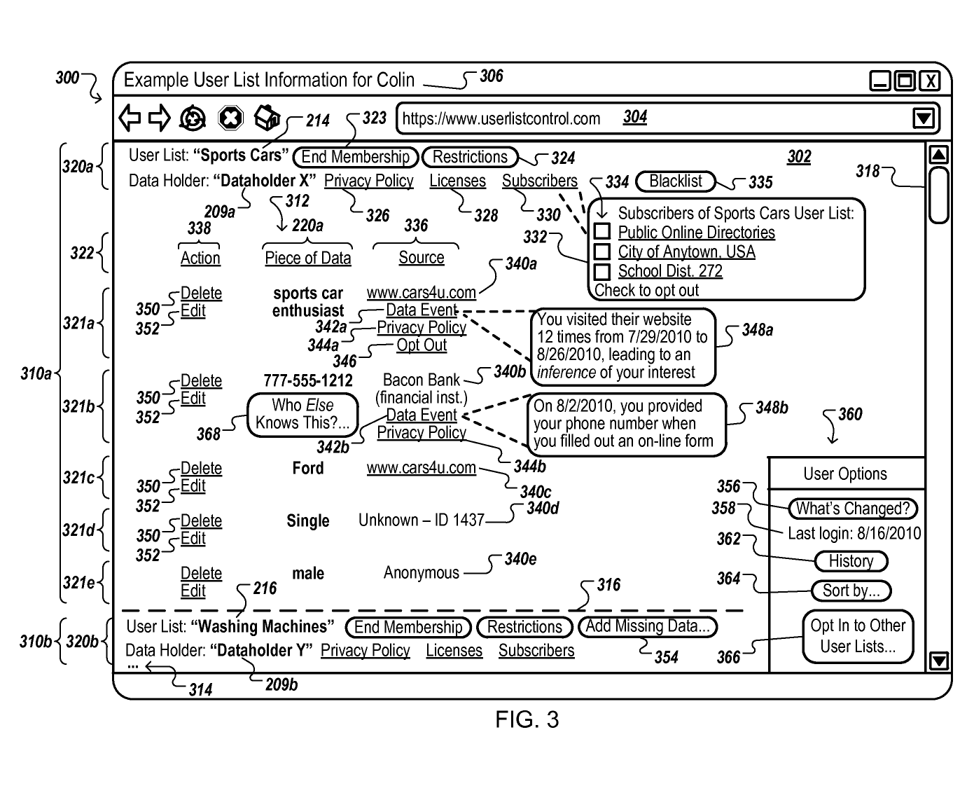

FIG. 3 is a screenshot 300 of an example user interface 302 for displaying user list information and providing user control of user-related information. For example, the user interface 302 can allow a user to review user data that includes information regarding user lists to which the user belongs and the identities of the one or more data holders that are associated with the user lists. In some implementations, the user data includes meta data (or pieces of data about the user) that has been derived by the data holders, by the data exchange 102, or by the data sources from which the data holders receive the user data. For example, referring to FIG. 2, a user such as Colin can use the user interface 302 to identify the user lists (e.g., Sports Cars, Washing Machines, and Green Living) to which the Colin has membership, the meta data associated with those memberships, and the data holders (e.g., Dataholders 209a-209c) who hold Colin's information, or who own the user lists. The display of the example user interface 302 (e.g., in user Colin's browser) can occur in response to the data exchange engine 102 receiving a request to review user data, such a request that includes an identifier associated with the user (e.g., Colin). In some implementations, a user (e.g., Colin) can use the user interface 302 to determine individual pieces of user data (e.g., meta data) in the user lists, sources of each piece of data, the data holders who hold the user data in the user lists, subscribers of the user lists, licensing agreements related to the user lists, the and privacy policies of specific data holders, subscribers, etc.

In some implementations, functionalities that are provided by the user interface 302 can be part of a Web application. For example, the application can be run from a user's web browser (e.g., as extended browser controls) and may use a common set of open API's. In some implementations, the example user interface 302 can be an extension of the Ads Preference Manager that is produced by Google.

In some implementations, a user can use the user interface 302, for example, to display and update (e.g., add, modify or delete) user list information, such as in one or more user lists 104 described with reference to FIG. 2. For example, referring to FIG. 2, the user 212 named Colin can use the user interface 302 to access the current information that data holders currently have for Colin, including pieces of data (e.g., phone numbers, brands, preferences, demographic information, etc.) in table 200 entries 220a-220c. Specifically, the entries 220a-220c each correspond to a separate user list, represented by column 214 (i.e., Sports Cars), column 216 (i.e., Washing Machines) and column 218 (i.e., Green Living). The example user interface 302 is just one example of a user interface that allows a user to view and control his user-related information. In other implementations, different types and formats of user interfaces can exist, and each can present the information and tools for managing the user's information in several other various ways.

In some implementations, the user can access the user interface 302 via his browser, such as by visiting a secure website that facilitates user control of user-related data (e.g., https://www.userlistcontrol.com, as indicated in an address field 304). A header 306 can identify the information within the user interface 302 as user list information that is associated with “Colin.” In some implementations, the name that appears in the header 306 may not agree with one or more names that are included in user list information. In some implementations, the name “Colin” or any other name that is displayed can be the name under which the user (e.g., Colin Anderson) registered for the service that provides access to his user list information. At the same time, names that appear in user lists for Colin Anderson may be nicknames, aliases, or different versions (e.g., including misspellings) of Colin's name, all of which can be tied together to comprise user lists for Colin based on various pieces of information (e.g., names, IP addresses, phone numbers, addresses, account numbers, demographic information, geo-location, etc.).

In the example shown in FIG. 3, the user interface 302 displays information for two of Colin's user lists. For example, an area 310a displays information for the “Sports Cars” user list (e.g., represented by column 214 in FIG. 2). In this case, all of the data elements that are contained in the entry 220a are included in a pieces-of-data column 312 that can include entries that correspond to the pieces of data stored in entries 220a-220c (e.g., 220a for the Sports Cars user list). Specifically, the information in the pieces-of-data column 312 corresponds to the information in the entry 220a (i.e., yes, 777-555-1212, Ford, single, male). In this example, the “yes” is an indication that Colin is interested in sports cars, or is a sports cars enthusiast. Another example area 310b includes some of the information related to the Washing Machines user list (e.g., represented by column 216 in FIG. 2). While FIG. 3 does not show the pieces of data related to Colin in the Washing Machines user list, the missing pieces of data (i.e., yes, Maytag, recent homebuyer) are represented by ellipses 314. In the example shown, a dashed line 316 indicates a dividing line between the two areas 310a and 310b, or between Colin's first two user lists that are displayed. In some implementations, the user interface 302 can include a scroll bar 318 or other control(s) for accessing or navigating to information that does not appear within the viewport of the screen. For example, Colin can use the scroll bar 318 to see the remaining information for the Washing Machines user list, as well as information for the Green Living user list.

As shown in FIG. 3, the area 310a includes a user list header 320a that includes information for the “Sports Cars” user list, further identifying, to the user, that the data holder for the user list is the “Dataholder X” 209a. Similarly, the area 310b includes a user list header area 320b that includes information for the “Washing Machines” user list, further identifying the data holder as the “Dataholder Y” 209b.

The area 310a also includes data rows 321a-321e, each data row corresponding to an individual piece of data (e.g., sports car enthusiast, 777-555-1212, Ford, single, male) for the user that is associated with the user list. Each of the rows 321a-321e include information arranged in columns, with column headers 323 that identify the type of information in each column (e.g., “Action . . . Piece of Data . . . Source”).

The information described in the example user interface 302 up to this point is simply the information that is contained for entries (e.g., entries 210a and 210b) for Colin that correspond to the user lists 104 of which Colin is a member. The example user interface 302 also includes several other components (e.g., displays, options, controls, etc.) that the user (e.g., Colin) can use to determine information about his user-related information, including its source, e.g., where, when and how it was obtained and by whom. Moreover, the example user interface 302 includes controls that facilitate user interaction with and control of the data. For example, using the other components (e.g., displays, options, controls, etc.), Colin can manage the user-related data that data holders hold for him, including modifying and deleting data, or adding new data, and controlling the data's use, as will now be described.

In general, the example user interface 302 includes information and controls at two levels: the user list level and the piece-of-data level. For example, beginning with the user list level, the example user list header 320a includes controls in addition to identifying the Sports Cars user list. For instance, the example user list header 320a that is shown in FIG. 3 includes an end membership control 323 and a restrictions control 324. Other implementations of the user list header 320a can include other controls not shown in FIG. 3.

By using the end membership control 323, for example, a user can remove (e.g., permanently) his information from the corresponding user list. As an example, Colin may see information in the pieces-of-data column 312 that Colin determines should not be known to data holders. Colin may make this determination for any of several reasons, including to hide private information, to remove false information, and so on. As a result of selecting the end membership control 323, for example, Colin's membership in the user list can end, and with it, the entry 310a in table 200 can be cleared. In some implementations, Colin's removal from the user list can occur instantaneously. In some implementations, user actions, including ending membership in a user list, can occur later, such as at the end of the user's session using the user interface 302 or some later time.

In some implementations, the user can use the end membership control 323 to blacklist certain entities (e.g., data-holding companies) from having any information about them. In some implementations, selecting the end membership control 323 can provide an option for the user to designate that the data holder associated with the user list is no longer allowed to maintain data for the user. In some implementations, the example user interface 302 can include a separate control (not shown) with which the user can designate one or more data holders that are not allowed to maintain data for the user.

In some implementations, users can use one or more controls, such as the restrictions control 324, to add restrictions as to the use of their data, e.g., to restrict how user data that is associated with the user list is used, for example, by data holders, or advertisers. As an example, upon the user selecting the restrictions control 324, the user interface 302 can display a restrictions interface (e.g., popup) that can receive user input indicating one or more restrictions for use of the user's data. In some implementations, the restrictions interface may include, for example, checkboxes that the user can check to turn on (or turn off) restrictions. In some implementations, the data exchange 102 can enforce the one or more restrictions that the user specifies, such as restrictions regarding dynamic ad generation, targeting and reporting, or restrictions that exclude certain entities and systems from using the data. Example restrictions that the user may specify include, “Don't use my user data on Right Media” and “Don't use my user data for dynamic ad generation,” to name a few examples.

Other restrictions that the user can specify using the restrictions control 324 and resulting restrictions interface include restrictions that involve monetary conditions. For example, in some implementations, the user can specify that his user data only be used on one or more particular websites (e.g., so that all or a percentage of the profits derived from the use of the user data can accrue to the website(s) that the user likes). In some implementations, the restrictions interface can include an input control in which the user can type in website URLs, or pull the information from other sources (e.g., Favorites, etc.).

In some implementations, users can attach additional monetary conditions as to the use of their data. For example, using a monetary restrictions interface (not shown) on the example user interface 302, the user can specify conditions related to how money is to be paid by consumers of the user's user data (e.g., ad providers). For example, a user can require an additional 10% of media spend (or a fixed CPM) for any ad impressions that use their data. In some implementations, the payment to the user in this scenario can be made to the user's online payment account, to the user's savings or checking account, or to some other account.

In some implementations, the user can specify additional monetary conditions by which an entity other than the user can receive a portion of the money paid by consumers (e.g., an ad provider) of user data (e.g., instead of the user receiving monetary rewards himself). For example, the user can use controls and fields on the monetary restrictions interface to select one or more ad publishers (or one or more non-profit charities, e.g., as a donation from the user) that will get credit for use of the user's user data.

Some implementations of the user interface can provide statistical information to the user that relates to monies associated with subscribers' use of a user's data. For example, the monetary restrictions interface or other interface within the user interface 302 can display statistics as to how much revenue has resulted from the use by subscribers of the user's data. In some implementations, the statistics can be provided on a per-subscriber basis and can identify how much revenue the subscriber has earned, how much has been paid to the user, and how much has been paid to the user's one or more designated charities. In some implementations, in order to remove the incentive for a user to view or click ads associated with his user data, the statistics can be based on actual revenue collected from an average user and not simply the one particular user.

Some implementations of the user interface can provide a tool that allows a user to display statistics related to audience insights/analytics related to the use of the user data. As an example, the user interface 302 can provide an “audience insights/analytics” control (not shown in FIG. 3) that the user can select to view audience-related statistics. For example, one statistic may identify the number of males, ages 18-24, who are soccer fans and who responded to ads that use user data from user lists associated with the user.

In addition to identifying the user list name and providing user list-related controls (e.g., controls 324 and 326), some implementations of the user list header 320a include information for the data holder (e.g., Dataholder X 209a) who may be the owner of the user list (e.g., the Sports Cars user list associated with column 214 of table 200). In some implementations, the user list header 320a includes a privacy policy control 326, a licenses control 328, and a subscribers control 330. The user list header 320a can include other data holder-related controls that are not shown in FIG. 3.

In some implementations, a user can select the privacy policy control 326, for example, to display a popup (or navigate to a website) that contains the data provider's privacy policy that the user can read to see how the user's information and privacy are protected by the data holder. In some implementations, the popup that is displayed can also allow the user to view the privacy policies of subscribers to the user list, privacy policies of the sources of information (e.g., websites, etc.) from which the data holder receives user data, and so on.

Implementations of the licenses control 328 allow the user to access (e.g., by clicking on the licenses control 328) existing license arrangements that the data holder may have, for example, with subscribers, syndications, or sub-syndications. The user may view this information, for example, to understand how his user data is used and shared among the community of players that provide, use or sell user list information. The user can view individual licenses, for example, to see who has a license to use the user list and for what purpose.

The subscribers control 330 can lead the user to information about subscribers of the user list. In some implementations, subscriber information that the user may view (e.g., after selecting the subscribers control 330) can include any syndication and sub-syndication arrangements involving the subscriber. In some implementations, if a user's data has been syndicated, the syndication information can include a syndication chain that shows all entities that have access to the user's data including the data holder (or data provider). For example, the user may be able to follow the syndication chain all the way to the owner of the data (e.g., the data holder).

In some implementations, subscriber information can be provided in a subscribers popup 332. For example, for the Sports Cars user list, the subscribers popup 332 includes three subscribers of the user's information. In some implementations, the subscribers popup 332 (or other popup or interface used for listing subscribers) can include opt out controls (e.g., checkboxes) 334, which the user can check to end access to his information by a particular subscriber.

Some implementations of the user interface 302 allow the user to blacklist selected data holders, including data holders that are presented that appear to be anonymous or random. By blacklisting a data holder, the user's data can be removed from all user lists held by that data holder that include user data for the user. In some implementations, the user can blacklist a data holder by selecting a blacklist control 335. In some implementations, selecting the black list control 335 can display a list of user lists associated with the data holder, including the user list (e.g., Sports Cars) for which the blacklist control 335 appears. For example, instead of having a name such as “Dataholder X”, the name of the data holder may be more descriptive, and the user may decide not to blacklist these legitimate data holders. However, if a data holder name is displayed as “Unknown” or is just a random number (e.g., like source names 340d and 340e), then the user may decide to blacklist those data holders. In some implementations, the user interface 302 can also include controls for blacklisting unknown or anonymous sources, such as the sources associated with source names 340d and 340e.

User interface 302 includes the rows 321a-321e, for example, that are associated with the Sports Cars user list. Each of the rows 321a-321e includes a particular piece of data in the pieces-of-data column 312, the piece of data's source in a source column 336, and user actions in an actions column 338. In some implementations, the user can use information in the rows 321a-321e, for example, to view metadata (e.g., essentially the pieces of data) derived by the data holders or the data exchange 102 or others about the user. In the example shown, the metadata for the user is associated with the Sports Cars user list.

In the example shown in FIG. 3, the source column 336 for the row 321a that is associated with the piece of data “sports car enthusiast” includes a source name 340a (e.g., www.cars4u.com), a data event control 342a, a privacy policy link 344a, and an opt out control 346. Similarly the source column 336 for the row 321b that is associated with the piece of data “777-555-1212” includes a source name 340b (e.g., Bacon Bank, which is further identified on the user interface 302 as a financial institution), a data event control 342b, and a privacy policy link 344b. In some implementations, the user can use information in the source column 336, for example, to review metadata that includes inferred data and/or actionable data, including events that were used to produce the metadata. For example, if the user selects the data event control 342a, the user interface 302 can display a data event explanation 348a that says, “You visited their website 12 times from Jul. 29, 2010 to Aug. 26, 2010, leading to an inference of your interest.” This information identifies, for example, how www.cars4u.com inferred that Colin is a sports car enthusiast. In another example, if the user selects the data event control 342b, the user interface 302 can display a data event explanation 348b that says, “On Aug. 2, 2010, you provided your phone number when you filled out an on-line form.” In this case, Colin can learn that the data holder Dataholder X holds his phone number (e.g., 777-555-1212) because of Colin's action on a website (e.g., completing a form on Bacon Bank's website). These two examples show that user data can originate from inferences (e.g., based on user actions) or by raw events (e.g., user-provided information). Using this type of information, for example, Colin can see how each piece of data in each of his associated user lists was derived or generated.

In some implementations, the user interface 302 can also provide metadata relating to whether data associated with a user's membership in a user list was uploaded and, if so, when. For example, other displays (not shown on FIG. 3) can inform Colin whether his phone number has been uploaded.

Some implementations of the user interface 302 can provide metadata relating to whether data associated with a user's membership in a user list was based on online tags and which websites those tags were provided from. For example, the user interface 302 can identify, for Colin, if online tags fired, and if so, identify the particular websites and the dates and times that the online tags fired.

In some implementations, the user interface 302 can also provide metadata relating to the user and whether at least a portion of the metadata was inferred or was user provided. For example, this type of information can be included in popups such as data event explanations 348a and 348b.

Some implementations of the user interface 302 can provide information as to which website the user data came from. For example, the data sources can be identified in source names 340a-340e. In some situations, the source names may be anonymous (e.g., source names 340d, identified only by a number or by another generic identifier) or unknown (e.g., source names 340e).

In some implementations of the user interface 302, when user data is inferred, the user interface can provide an indication of who made the inference. For example, the data event explanation 348a that says that Colin visited www.cars4u.com “12 times from Jul. 29, 2010 to Aug. 26, 2010, leading to an inference of your interest” identifies how the inference was made.

Some implementations of the user interface 302 can provide a link to privacy policies under which any data was collected by a data holder. For example, the user can select the privacy policy link 344a to view the privacy policy for www.cars4u.com, or the privacy policy link 344b to view the privacy policy for Bacon Bank. In general, data suppliers such as cars4u and Bacon Bank who acquire their own and aggregated data can supply information for (or a link to) the privacy policies under which the data was collected. In some implementations, the information includes the web sites where the user's data was collected, the source if the information was acquired off-line, and the principal key on which the data is indexed. In some implementations, the data can be keyed or indexed by IP address, website, user cookie, etc.

In some implementations, the user interface 302 can provide an interface for users to opt out of user data collection by a specific originating data source. For example, if Colin sees that a particular piece of information has been copied to multiple other domains (e.g., another user list), Colin can select an option such as the opt out option 346 to block the corresponding source (e.g., www.cars4u.com) from obtaining future data from the user. In some implementations, this user preference in controlling the user's user-related data can be enforced by the data exchange engine 102, such as based on licensing or other agreements that the data exchange engine 102 may have with the website.

In some implementations, the user can elect to opt out at the data exchange level, which can lead to the deletion of all pieces of data in all user lists for that user. In some implementations, the source of the data can still retain its original copy of the user data, if any, that still exists at the source. In some implementations, if the user elects to opt out at the data exchange level, the data exchange engine 102, for example, can enforce propagation of the user's opt-out election down to the source, causing the source data to be deleted as well.

In some implementations, the user interface can provide a tool to allow a user to opt out of a complete set of anonymous sources associated with the user data. For example, the user interface 302 can include an “Opt out of all anonymous sources” control that has the same effect as the user selecting each individual opt out option 346 for each anonymous source.

In some implementations, user input can be received to suppress a cookie from being written to a user's client device for a predetermined period of time, and the user input can be provided to one or more data holders to ensure that cookies are suppressed for the predetermined period of time. For example, in addition to opt-out options for a particular data source, the user interface 302 can provide controls (not shown in FIG. 3) by which the user can suppress or pause their cookie from being written to by a specific website for some period of time. In one example, the user can specify (e.g., via a group of checkboxes) preferences such as “don't enable any writes to my cookie for the next 7 days) which, when enforced by the data exchange engine 102 (onto the website) can lead to a read-only browsing experience on that website by the user, or a form of in-private browsing.

In some implementations, the user interface can receive user input to delete or modify any particular data item. For example, upon reviewing any particular portion of user data (e.g., in the pieces-of-data column 312) and its source (e.g., in the source column 336), a user may want to delete the information or modify the information (e.g., if it is incorrect or outdated). In some implementations, the user can delete or update user data using available options (e.g., delete, update or modify) in the actions column 338. For example, each row 321a-321e can have its own set of available options that applies to that row's piece of data. To delete a piece of information, the user can select a delete option 350, which can delete that particular piece of data from the user list. In some implementations, the deletion can occur instantaneously. In some implementations, the piece of data can be marked for deletion on the screen, and the specified deletion and other user inputs during the same session can be applied all at once using a submit or commit control (not shown in FIG. 3).

To update a piece of information, the user can select an edit control 352. As a result, a popup or other interface can appear in which the user can make corrections to the information by editing characters in, for example, a free-form field, by selecting a new value from a list or fixed set of options, or in other ways. In some implementations, the user interface 302 can provide data validation rules or functions, e.g., to prevent the user from entering random characters in formatted fields (e.g., alphabetic letters in a phone number).

In some implementations, the user can provide input for user list-associated fields that are not filled in. For example, a particular user list to which the user is happy to be associated with may not have all of the information that the user list holds for typical members of the user list. In some implementations, for example, an “Add missing data” control 354 can appear which, when selected by the user, can allow the user to input remaining undefined fields. As an example, the Washing Machines user list may have a “front or top load preference” field that the user is more than happy to specify as “front.” In some implementations, the “front or top load preference” field can appear as any of the rows 321a-321e, and the value that is displayed in the pieces-of-data column 312 may be blank.

In some implementations, deletion of a piece of user data is a one-time event and does not prohibit the future gathering of similar data by the data holder. For example, while the user may delete his phone number from a user list on a particular day, a one-time event deletion will not prevent his phone number from being derived or loaded again sometime in the future. However, at the time that the user chooses to delete the data, the user can be assured that the information is erased from the user list, at least temporarily.

In some implementations, deletion of a piece of user data can be permanent and can inhibit future collection by the data holder of similar data. For example, if the user deletes his phone number from a particular user list, the data exchange engine 102 can enforce a policy that the data holder is never allowed to collect or hold that data again.

Some implementations of deleting a portion of data can include determining other data associated with the user that should also be deleted for, for example, consistency reasons. The other data can automatically be deleted. For example, if the user deletes a portion of his address (e.g., all or some of his house number, street name, city and state), the user interface 302 can automatically delete the user's ZIP code.

Some implementations of the user interface include receiving user input that includes the identification of a persistent authentication data entity related to the user and associating the persistent authentication data entity with the user data. For example, a user can to attach his (unauthenticated) data to a more persistent authenticated entity of the user's choosing. The user interface 302, for example, can provide a control (not shown in FIG. 3) that the user can select to copy or move one or more pieces of data in a user list (e.g., associated with a current data holder) to a user-selected data holder. Advantages of associating the information in this way can include the benefit of more persistent user preferences, e.g., preventing the loss of user data value aggregates that may occur from inadvertent cookie deletion or expiration.

Some implementations of the user interface can provide a tool to allow a user to see what user data has changed since a last time that the user reviewed the user data. For example, the user interface 302 can include a “What's Changed” control 356 so users can track what has been modified in the data about them since the last time they logged in (e.g., as indicated by a last login 358). In some implementations, the “What's Changed” control 356 and other options can be grouped in a user options area 360.

Some implementations of the user interface can provide an indication of whether the user data has changed since a last time that the user reviewed the user data. For example, the user interface 302 may display a message that says “Your data has changed” or “No changes to your data have occurred since the last time you looked,” to name a few examples.

In some implementations, the user interface 302 can include a history control 362 that the user can select, for example, to view past versions of user data and changes over time. Some implementations of the user interface 302 can include a “sort by” control 364 that the user can use, for example, to re-sort or present the data on the user interface 302 in a particular way (e.g., by most-often accessed user list).

Some implementations of the user interface 302 can include an “Opt in to other User Lists” control 366 that the user can use to identify additional user lists to which the user would like to become a member (e.g., if the user has suddenly developed an interest in a new hobby or product).

Some implementations of the user interface 302 can include a “Who Else Knows This?” control 368. Separate instances of the control 368 can exist for each piece of data. For example, the user may select the “Who Else Knows This?” control 368 that is adjacent to his phone number piece of data in order to determine if his phone number appears on other user lists.

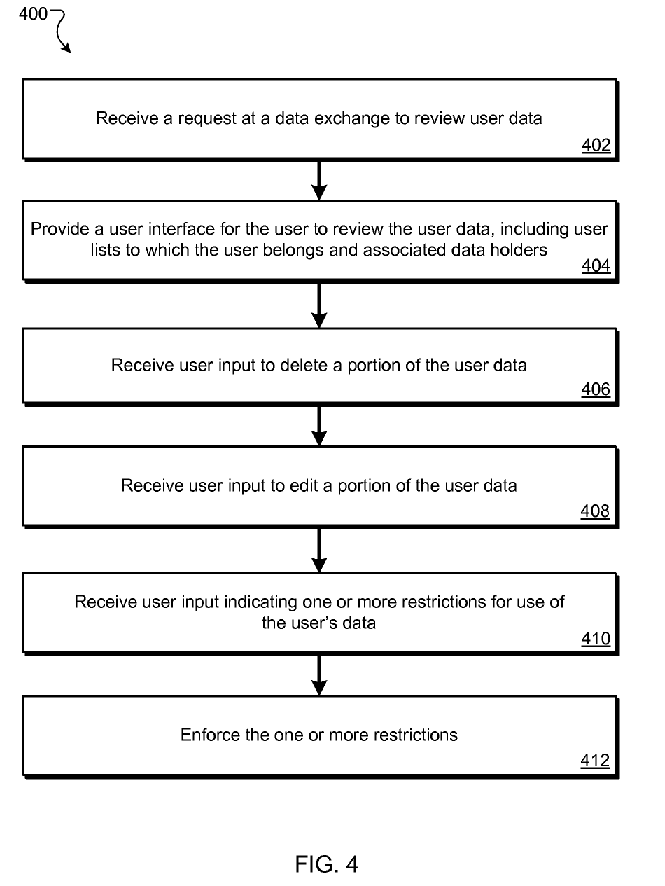

FIG. 4 is a flow diagram of an example process 400 for providing a user interface for a user to review and control the use of user-related data. As described above with reference to FIGS. 1-3, the user-related data can be in the form of user lists that are held by various data holders. The process 400 may be executed, for example, by the data exchange engine 102 shown in FIG. 1. For example, the data exchange engine 102 can provide one or more user interfaces, such as the user interface 302 described with reference to FIG. 3. More or fewer participants may be involved.

At stage 402, a request is received at a data exchange to review user data that has been gathered by one or more data holders. The requested user data relates to a given user. The user data may be marketed for use in the data exchange. The request to review user data includes an identifier associated with the user. For example, a user running a browser may access the data exchange engine 102 (e.g., using the Internet, etc.). In some implementations, the request to review user data may use the identifier associated with the user, for example, that the user provided during a registration process with the data exchange engine 102. Referring to FIG. 2, if the user is Colin, then Colin's request to review user data can include the type of information that is held in user lists by one or more data holders. Specifically, Colin may be interested in the pieces of data that exist in various user lists 104 to which Colin is a member. Example user data in which Colin is interested may include information that exists in entries 220a-220c. In this case, the information corresponds to user lists for Sports Cars, Washing Machines, and Green Living. In some cases, Colin may have no idea that he belongs to these user lists. In other cases, Colin may know of one or more user lists to which he belongs, but may access the example user interface 302 to determine the metadata (e.g., pieces of information) that are stored for him, as well as how the data originated and how it is used.

In some implementations, user registration in and access to the data exchange engine 102 (and access to the user interface 302) may require some sort of user authentication from the user. Furthermore, because user data can be sensitive and/or private, registration and access may not require the user to volunteer his own personally identifiable information. In some implementations, this can be done by having the user “claim” his profile before exposing his profile to them. For example, the profile can be claimed by identifying an image or series of images and asking the user to re-authenticate by identifying the image or common images each time the user interface 302 is accessed.

In some implementations, authentication can extend to cookies. For example, the data exchange engine 102 may require the user to take “ownership” of a cookie by associating it with a login and/or password. In some implementations, the data exchange engine 102, for example, can reset the attributes associated with the cookie so that some other user cannot access the current user's cookie. As a result, only the user who owns the cookie can see subsequent additions and/or changes to the cookie. In some implementations, a secondary secure cookie can be used for validating a user's access to the regular cookie. In some implementations, the data exchange engine 102 can user encryption to store user-related information, and the encryption key can be stored in the user's cookie. As a result, decryption of the information can only occur if the same user's cookie is accessed, which can prevent other users from accessing another user's information.

At stage 404, a user interface is provided for the user to review the user data. The user data that is reviewable on the user interface includes information, if any, regarding user lists to which the user belongs and an identity of a data holder that is associated with the user lists. In some implementations, the user interface that is provided is the user interface 302 that the user can access using the data exchange engine 102. For example, as described above with reference to FIG. 3, the user interface 302 can display the user lists (e.g., Sports Cars and Washing Machines) to the user Colin. The user interface 302 can further identify the data holder associated with each user list that is displayed for Colin.

At stage 406, user input is received to delete a portion of the user data. For example, the input can be received by the data exchange engine 102 as the user is using the user interface 302. Referring to FIG. 3, to delete a portion of user data, such as one of the fields in the pieces-of-data column 312 for example, the user can select the corresponding delete option 350 for a particular row 321a-321e, as described above.

At stage 408, user input is received to edit a portion of the user data. As an example, the input can be received by the data exchange engine 102 as the user is using the user interface 302. To edit a portion of user data, such as one of the fields in the pieces-of-data column 312 for example, the user can select the corresponding edit option 352 for a particular row 321a-321e, as described above.

At stage 410, user input is received that indicates one or more restrictions for use of a user's data. For example, the input can be received by the data exchange engine 102 when the user selects the restrictions control 324 and subsequently provides or defines restrictions for the use of his data.

At stage 412, the one or more restrictions are enforced. As an example, the data exchange engine 102 can enforce the restrictions that the user has provided, such as by granting access to and use of user information by particular data holders as described above, or by enforcing monetary-related restrictions provided by the user, to name a few examples.

Other stages in the process 400 are possible, based on the functionality of the user interface 302 described above with reference to FIG. 3. Further, the stages in the process 400 can be performed in any appropriate order. Moreover, stages 406-412 can be optional, for example, if a user does not wish to delete or edit particular portions of user data, nor provide restrictions for the use of the user data.

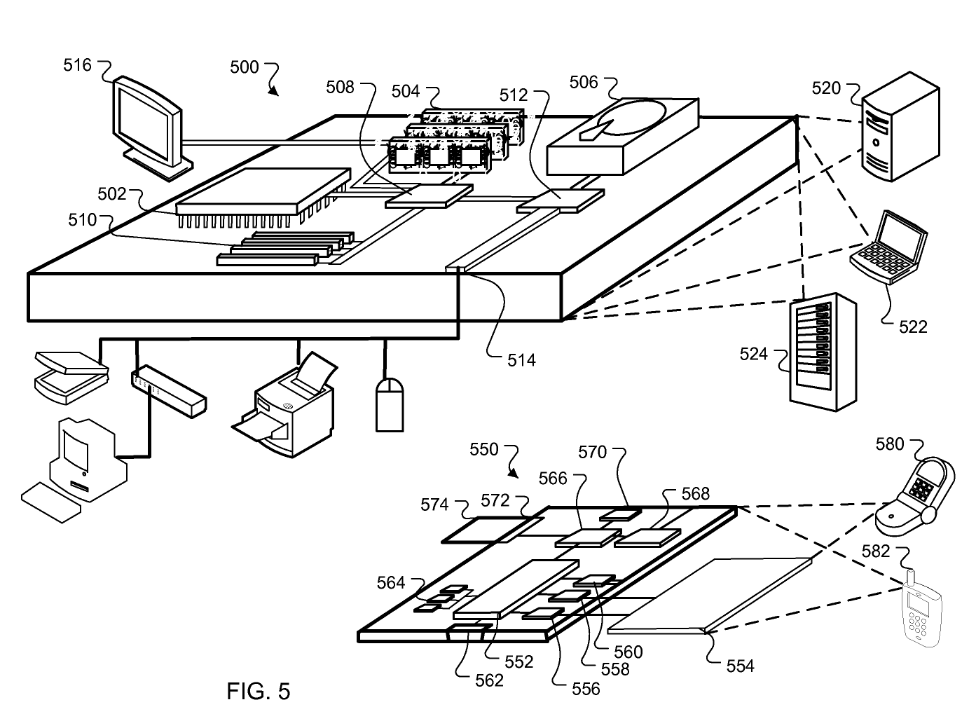

FIG. 5 shows an example of a generic computer device 500 and a generic mobile computer device 550 which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to advertisements, but other forms of future, content delivery may also be supported.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
receiving at a data exchange a request to review user data that has been gathered by one or more data holders and that relate to a given user, where the user data is being marketed for use in the data exchange, where the request includes an identifier associated with the user; and
providing a user interface for the user to review the user data wherein the user data includes information, if any, regarding user lists that the user belongs to and an identity of a data holder that is associated with the user lists.

2. The method of claim 1 where the user interface includes meta data derived by the data holders or the data exchange about the user.

3. The method of claim 2 where the metadata includes inferred data and/or actionable data including events that were used to produce the metadata.

4. The method of claim 1 wherein providing the user interface includes providing information as to subscribers to a user list in which a user is a member.

5. The method of claim 4 where the subscribers are syndicates or sub-syndicates.

6. The method of claim 1 wherein providing the user interface includes providing metadata relating to whether data associated with a user's membership in a user list was uploaded and if so when.

7. The method of claim 1 where providing the user interface includes providing metadata relating to whether data associated with a user's membership in a user list was based on online tags and which websites those tags were provided from.

8. The method of claim 1 where providing the user interface includes providing metadata relating to the user and whether at least a portion of the metadata was inferred or was user provided.

9. The method of claim 8 wherein for user provided data, providing a user interface that includes information as to which website the user data came from.

10. The method of claim 8, wherein for user inferred data, providing an indication of who made the inference.

11. The method of claim 1 where if a user's data has been syndicated, providing the user interface includes providing a syndication chain that shows all entities that have access to the user's data including the data holder.

12. The method of claim 1 wherein providing a user interface includes providing information including a link to privacy policies under which any data was collected by a data holder.

13. The method of claim 12 where the information includes the web sites where the user's data was collected, the source if the information is off-line and the principal key on which the data is indexed.

14. The method of claim 1 further comprising providing an interface for users to opt out of user data collection by a specific originating data source.

15. The method of claim 14 further comprising receiving user input to delete a portion of the user data.

16. The method of claim 14 where the deletion is a one time event and does not prohibit the future gathering of similar data by the data holder.

17. The method of claim 14 where the deletion is permanent and will inhibit future collection by the data holder of similar data.

18. The method of claim 1 further comprising receiving user input designating one or more data holders that are not allowed to maintain data for a given user.

19. The method of claim 18 wherein the user input includes user input specifying a blacklist of websites or categories of data holders that are prohibited from adding data about a user to a user list.

20. The method of claim 14 where upon receipt of user input to delete a portion of data, determining other data associated with the user that should be deleted for consistency reasons and the method further comprising deleting the other data.

21. The method of claim 1 further comprising receiving user input to suppress a cookie from being written to a user's client device for a predetermined period of time and the method further comprising providing the user input to one or more data holders to ensure that cookies are suppressed for the predetermined period of time.

22. The method of claim 1 further comprising receiving user input to edit a portion of the user data.

23. The method of claim 1 wherein in the data holder is presented to the user as an anonymous entity, and wherein the method further includes receiving user input to blacklist one or more data holders that have chosen to be anonymous and removing user data associated with the user for the one or more data holders.

24. The method of claim 1 further comprising receiving user input indicating one or more restrictions for use of a user's data.

25. The method of claim 24 further comprising, enforcing the one or more restrictions.

26. The method of claim 24 where the restrictions relate to dynamic ad generation, targeting and reporting, including restrictions that exclude certain entities and systems from using the data.

27. The method of claim 24 where the restrictions relate to sites the user specifies so that user data can only be used on sites specified by the user.

28. The method of claim 1 further input including conditions on use of user data, where the conditions relate to money to be paid by consumers of user data.

29. The method of claim 28 where the conditions specify an entity other than the user for receiving a portion of the money paid by consumers of user data.

30. The method of claim 28 further comprising providing statistical information to the user related to monies paid to subscribers of a user's data.

31. The method of claim 28 further comprising providing relative statistical information to the user related to monies paid to subscribers of a user's data.

32. The method of claim 1 further comprising receiving user input including identification of a persistent authentication data entity related to the user and associating the persistent authentication data entity with the user data.

33. The method of claim 1 further comprising providing a tool to allow a user to see what user data has changed since a last time that the user reviewed the user data.

34. The method of claim 1 further comprising providing in the user interface an indication of whether the user data has changed since a last time a user reviewed the user data.

35. The method of claim 1 further comprising providing a tool to allow a user to become a member of a user list of which the user is not currently a member.

36. The method of claim 1 further comprising providing a tool to allow a user to display statistics related to audience insights/analytics related to the use of the user data.

37. The method of claim 1 further comprising providing a tool to allow a user to opt out of a complete set of anonymous sources associated with the user data.
